(19) United States
(12) Patent Application Publication
(10) Pub. No.: US 2014/0164334 A1
(43) Pub. Date: Jun. 12, 2014

(54) DATA BLOCK BACKUP SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHI-QUAN CHAI, Shenzhen (CN); DA-PENG LI, Shenzhen (CN); CHIEN-FA YEH, New Taipei (TW); HAI-HONG LIN, Shenzhen (CN); CHUNG-I LEE, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/065,487

(22) Filed: Oct. 29, 2013

(30) Foreign Application Priority Data
Dec. 12, 2012 (CN) 2012105339709

(51) Int. Cl. G06F 11/14; G06F 17/30

(52) U.S. Cl. CPC G06F 11/1448; G06F 17/3007
USPC 707/652

(57) ABSTRACT

A server uploads each data block of the file into a first storage space of the server. The server deletes repetitive data blocks of the file from the first storage space. The server backs up the repetitive data blocks into a third storage space of the server from the first storage space when the repetitive data blocks are not backed up, and backs up the uploaded data blocks of the file into the third storage space from a second storage space of the server.

### BACKGROUND

1. Technical Field

The embodiments of the present disclosure relate to management technology, and particularly to a data block backup system and method.

2. Description of Related Art

A data center is a facility which houses a large number of computers and stores huge amounts of data. By using cloud computing, the files are uploaded into a data center. However, a file stored in the data center may include one or more same portions, which waste a lot of storage spaces. Therefore, there is room for improvement in the art.

### BRIEF DESCRIPTION OF THE DRAWINGS

FIG. 1 is a block view of one embodiment of a data block backup system.

FIG. 2 is a block diagram of one embodiment of function modules of the data block backup unit in the server of FIG. 1.

FIG. 3 is a flowchart of one embodiment of a data block backup method.

FIG. 4 is a flowchart of one embodiment of downloading a file from a server.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

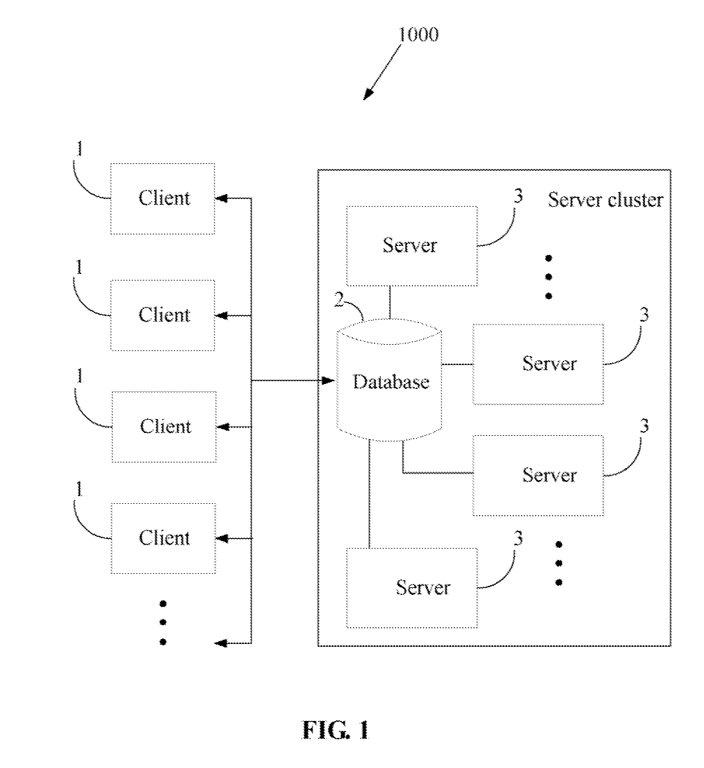

FIG. 1 is a block diagram of one embodiment of a data block backup system 1000. The data block backup system 1000 includes one or more clients 1, a database 2 and one or more servers 3. The server 3 connects to one or more clients 1 via a network (e.g., the Internet or a local area network). Each client 1 may provide a user interface, which is displayed on a display device of the client 1, for a user to access the server 3 and control one or more operations of the server 3. The user may input an ID and a password using an input device (e.g., a keyboard) into the user interface to access the server 3. The client 1 may be, but is not limited to, a mobile phone, a tablet computer, a personal computer or other data-processing apparatus. The server 3 connects to a database 2 using a data connectivity, such as open database connectivity (ODBC) or JAVA database connectivity (JDBC), for example. The servers 3 store files uploaded from the one or more clients 1 through the network. Each server 3 includes three storage spaces, namely a first storage space, a second storage space, and a third storage space. The first storage space temporarily stores the files before storing the files into the second storage space. The second storage space formally stores the files. The third storage space backs up the files.

In one embodiment, when the client 1 sends a file to a server 3, the server 3 divides each file into two or more data blocks. Additionally, before saving the two or more data blocks of the file into the server 3, the server 3 further calculates a hash value of each data block and saves the hash value of each data block into a hash list. The server 3 also receives information of each file sent from client 1. The information of each file includes a name of the file and an attribute of the file. Furthermore, each file corresponds to a hash list. In other words, the data blocks of each file are saved into the hash list corresponding to the file. Each data block includes a name. The name of each data block is generated in order and also saved into the hash list. In detail, the name of each data block is generated by the hash value of the data block. For example, the name of each data block may be the same as the hash value of the data block. Each data block also includes a sequence number. The sequence number of each data block is generated in an alphabetical order (e.g., “a,” “b,” “c,” “d,” “d,” or “f”) or in a numerical order (e.g., “1,” “2,” “3,” or “4”). Each data block may include a storage capacity predetermined by a user, such as 16 KB, 32 KB, 64 KB, 128 KB, or 256 KB. For example, if the storage capacity is predetermined as 32 KB, the file is divided into a plurality of data blocks, and each data block is 32 KB.

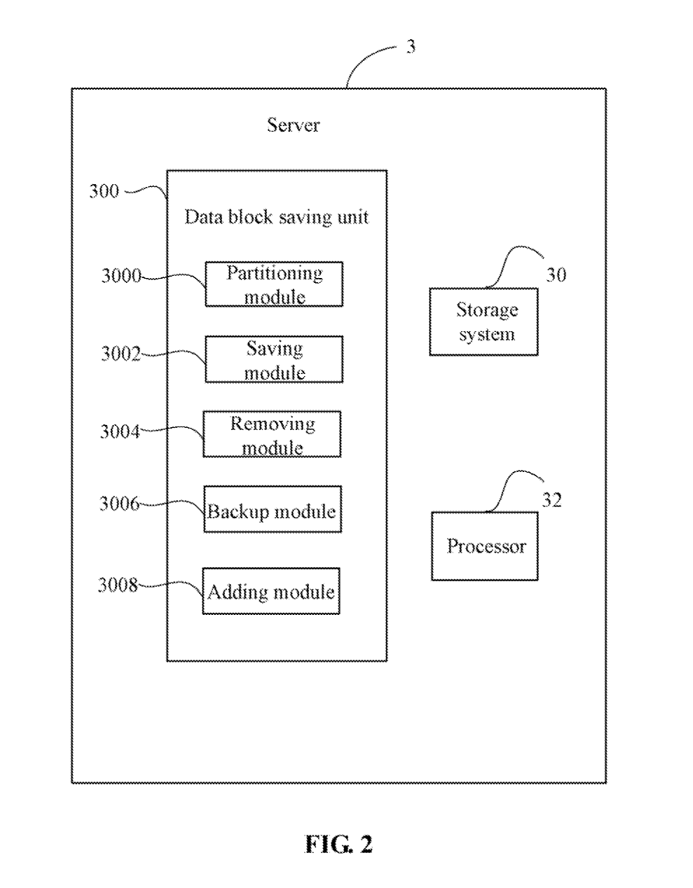

FIG. 2 is a block diagram of one embodiment of the data block backup unit 300 included in the server 3 of FIG. 1. The data block backup unit 300 backs up data blocks of a file into the server 3. In one embodiment, the server 3 further includes a storage system 30 and at least one processor 32. The data block backup unit 300 includes a dividing module 3000, a saving module 3002, a removing module 3004, a backup module 3006, and an adding module 3008. The modules 3000-3008 may include computerized code in the form of one or more programs that are stored in the storage system 30. The computerized code includes instructions that are executed by the at least one processor 32 to provide functions for the modules 3000-3008. The storage system 30 may be a memory, such as an EPROM memory chip, hard disk drive (HDD), or flash memory stick.

The dividing module 3000 divides a file into two or more data blocks and saves a hash value of each data block into a hash list corresponding to the file.

The saving module 3002 uploads the hash list corresponding to the file into a database 2, and uploads each data block into a first storage space of a server 3 according to a sequence number of each data block. In one embodiment, if the file is divided into three data blocks, the sequence number of the three data blocks may be “a,” “b,” and “c,” and the saving module 3002 saves the data blocks into the first storage space of the server 3 in order from “a” to “c.”

The removing module 3004 determines if the uploaded data blocks of the file exist in a second storage space according to the hash values of the uploaded data blocks. In one embodiment, the removing module 3004 searches the second storage space and determines if each uploaded data block of the file exists in a second storage space. The removing module 3004 compares the hash values of the uploaded data blocks with the hash values of the data blocks stored in the second storage space, and determine if the each uploaded data block of the file exists in the second storage space according to the comparison result. The uploaded data block exists in the second storage space upon the condition that the hash value of the uploaded data block is the same as the hash value of the data block stored in the second storage space.

The removing module 3004 determines the uploaded data blocks as the repetitive data blocks and deletes the repetitive data blocks from the first storage space when the uploaded data blocks exist in the second storage space. In one embodiment, the data block in the first storage space is determined as a repetitive data block upon the condition that the data block has already been stored in the second storage space.

The removing module 3004 saves uploaded data blocks into the second storage space when the uploaded data blocks does not exist in the second storage space.

The backup module 3006 determines if the repetitive data blocks are backed up in a third storage space.

The backup module 3006 backs up the repetitive data blocks into the third storage when the repetitive data blocks are not backed up, and backs up the uploaded data blocks into the third storage space from the second storage space.

The adding module 3008 adds a first pointer corresponding to each uploaded data block of the file in the second storage space and a second pointer corresponding to each data block of the file in the third storage space into the database 4. Each data block corresponds to the first pointer that points to the first storage space of the server 3. In other words, a user uses the pointer to find the storage space and knows where the data block is saved in the first storage space of the server 3. The storage space may store one or more data blocks in the server 3. Each data block also corresponds to the second pointer that points to the second storage space of the server 3.

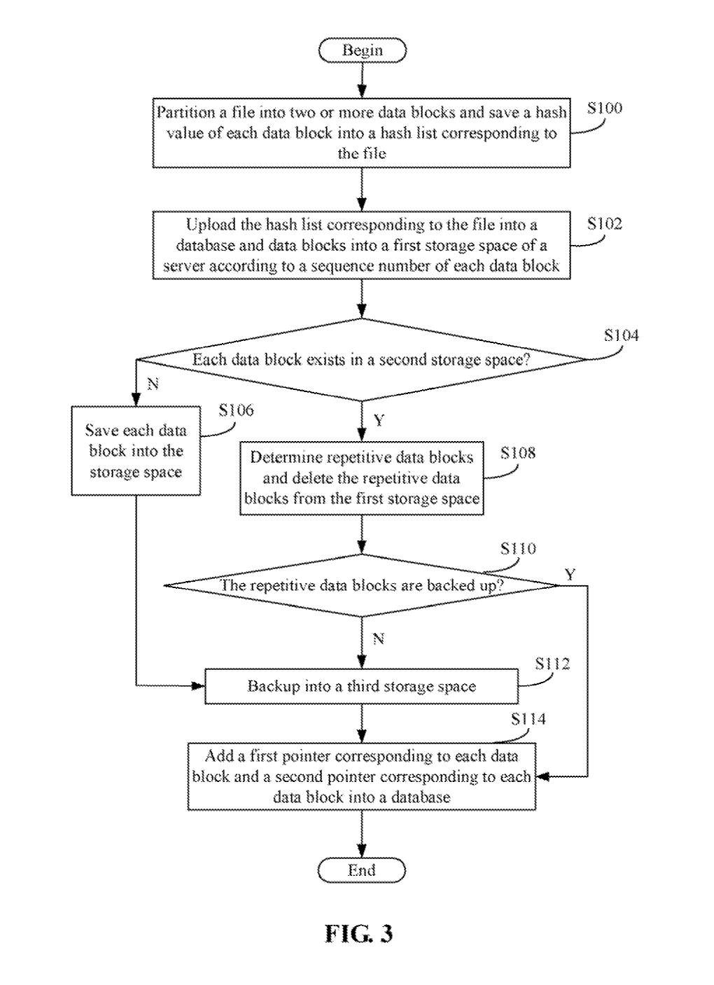

FIG. 3 is a flowchart of one embodiment of a data block backup method. Depending on the embodiment, additional steps may be added, others deleted, and the ordering of the steps may be changed

In step S100, the dividing module 3000 divides a file into two or more data blocks and saves a hash value of each data block into a hash list corresponding to the file.

In step S102, the saving module 3002 uploads the hash list corresponding to the file into a database 2 and each data block of the file into a first storage space of a server 3 according to a sequence number of each data block.

In step S104, the removing module 3004 determines if the uploaded data blocks of the file exist in a second storage space according to the hash values of the uploaded data blocks. In one embodiment, if the uploaded data blocks of the file exist in the second storage space, the procedure goes to step S108. If the uploaded data blocks of the file do not exist in the second storage space, the procedure goes to step S106.

In step S106, the removing module 3004 removes the uploaded data blocks of the file into the second storage space from the first storage space when the uploaded data blocks of the file do not exist in the second storage space of the server.

In step S108, the removing module 3004 determines the uploaded data blocks as the repetitive data blocks and deletes the repetitive data blocks from the first storage space when the uploaded data blocks exist in the second storage space, then the procedure goes to step S110. In one embodiment, the uploaded data block in the first storage space is determined as a repetitive data block upon the condition that the uploaded data block has already stored in the second storage space.

In step S110, the backup module 3006 determines if the repetitive data blocks are backed up in a third storage space. If the repetitive data blocks are not backed up in the third storage space, the procedure goes to step S112. Otherwise, if the repetitive data blocks are backed up in the third storage space, the procedure goes to step S114.

In step S112, the backup module 3006 backs up the repetitive data blocks by removing the repetitive data blocks from the first storage space into a third storage space of the server when the repetitive data blocks are not backed up, and backs up the uploaded data blocks of the file removing the uploaded data blocks of the file from the second storage space into the third storage space.

In step S114, the adding module 3008 adds a first pointer corresponding to each data block in the second storage space and a second pointer corresponding to each data block in the third storage space into the database 4.

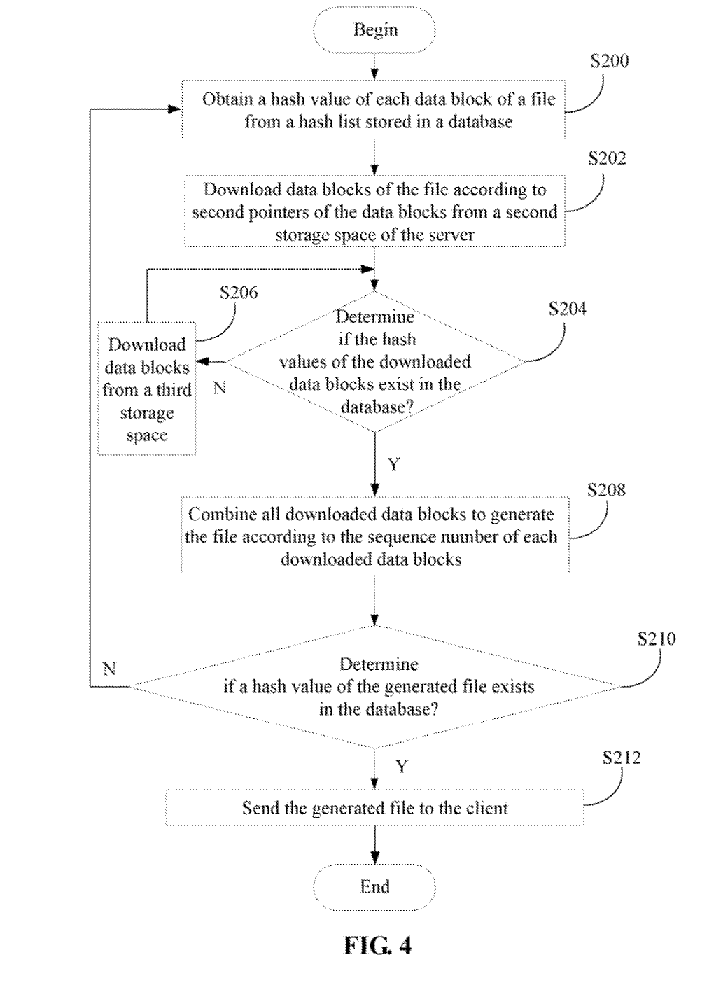

FIG. 4 is a flowchart of one embodiment of downloading a file from a server.

In step S200, the client 1 obtains a hash value of each data block of a file from a hash list stored in a database 2.

In step S202, the client 1 downloads each data block of the file according to a first pointer of each data block from the second storage space of the server 3.

In step S204, the client 1 calculates a hash value of each downloaded data block and determines if the hash value of each downloaded data block exists in the hash list stored in the database 2. In one embodiment, if the calculated hash value of each downloaded data block exists in the database 2, the procedure goes to step S208. Otherwise, if one calculated hash value of the downloaded data block does not exist in the hash list, the procedure returns to step S206.

In step S206, the client 1 downloads data blocks from a third storage space according to the second pointers of the data blocks, then the procedure returns to step S204.

In step S208, the client 1 combines all downloaded data blocks to generate the file in the temporary storage space of the client 1 according to the sequence number of each downloaded data block. The temporary storage space of the client 1 may be, but is not limited to, a random access memory (RAM). In one embodiment, due to the sequence number of each downloaded data block is generated in order, and the client 1 combines all downloaded data blocks to generate the file in order of the sequence number of each downloaded data block.

In step S210, the client 1 calculates the hash value of the generated file and determines if the calculated hash value of the generated file exists in the hash list stored in the database 2. If the calculated hash value of the generated file exists in the hash list, the procedure goes to step S210. If the calculated hash value of the generated file does not exists in the hash list, the client 1 displays fail information (e.g., display “FAIL”) on the display device of the client 1, and the procedure returns to step S200.

In step S212, the client 1 displays the generated file and success information (e.g., display “SUCCESS”) on a display device of the client 1

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A server in electronic communication with a plurality of clients and a database, comprising:
at least one processor; and
a storage system that stores one or more programs, when executed by the at least one processor, cause the at least one processor to perform a data block backup method, the method comprising:
dividing a file into two or more data blocks and saving a hash value of each data block into a hash list corresponding to the file;
uploading the hash list corresponding to the file into the database and each data block of the file into a first storage space of the server according to a sequence number of each data block of the file;
deleting repetitive data blocks from the first storage space when the uploaded data blocks of the file exist in a second storage space of the server;
removing the uploaded data blocks of the file into the second storage space from the first storage space when the uploaded data blocks of the file do not exist in the second storage space of the server;
backing up the repetitive data blocks by removing the repetitive data blocks from the first storage space into a third storage space of the server when the repetitive data blocks are not backed up, and backing up the uploaded data blocks of the file by removing the uploaded data blocks of the file from the second storage space into the third storage space; and
adding a first pointer corresponding to each uploaded data block of the file in the second storage space and a second pointer corresponding to each uploaded data block of the file in the third storage space into the database.

2. The server of claim 1, wherein a method of dividing the file by the server comprises:
the server divides the file into two or more data blocks;
the server calculates the hash value of each data block; and
the server saves the hash value of each data block into the hash list.

3. The server of claim 1, wherein the sequence number of each data block is generated in an alphabetical order or in a numerical order.

4. The server of claim 1, wherein the uploaded data block exists in the second storage space upon the condition that the hash value of the uploaded data block is the same as the hash value of the data block stored in the second storage space.

5. The server of claim 1, wherein a uploaded data block in the first storage space is determined as a repetitive data block upon the condition that the uploaded data block also exists in the second storage space.

6. The server of claim 1, wherein a method of downloading the file from the server comprises:
the client obtains the hash value of each data block of the file from the hash list stored in the database;
the client downloads data blocks of the file from the second storage space according to the first pointers of the data blocks from the server when the hash values of the data blocks exist in the hash list stored in the database;
the client downloads the data blocks from a third storage space according to the second pointers of the data blocks when the hash values of the data blocks does not exist in the hash list stored in the database;
the client combines all downloaded data blocks to generate the file in the client according to the sequence number of each downloaded data block;
the client calculates the hash value of the generated file and determines if the calculated hash value of the generated file exists in the hash list stored in the database; and
the client displays the generated file when the calculated hash value of the generated file exists in the hash list stored in the database.

7. A data block backup method implemented by a server, the server in electronic communication with a plurality of clients and a database, the method comprising:
dividing a file into two or more data blocks and saving a hash value of each data block into a hash list corresponding to the file;
uploading the hash list corresponding to the file into the database and each data block of the file into a first storage space of the server according to a sequence number of each data block of the file;
deleting repetitive data blocks from the first storage space when the uploaded data blocks of the file exist in a second storage space of the server;
removing the uploaded data blocks of the file into the second storage space from the first storage space when the uploaded data blocks of the file do not exist in the second storage space of the server;
backing up the repetitive data blocks by removing the repetitive data blocks from the first storage space into a third storage space of the server when the repetitive data blocks are not backed up, and backing up the uploaded data blocks of the file by removing the uploaded data blocks of the file from the second storage space into the third storage space; and
adding a first pointer corresponding to each uploaded data block of the file in the second storage space and a second pointer corresponding to each uploaded data block of the file in the third storage space into the database.

8. The method of claim 7, wherein a method of dividing the file by the server comprises:
the server divides the file into two or more data blocks;
the server calculates the hash value of each data block; and
the server saves the hash value of each data block into the hash list.

9. The method of claim 7, wherein the sequence number of each data block is generated in an alphabetical order or in a numerical order.

10. The method of claim 7, wherein the uploaded data block exists in the second storage space upon the condition that the hash value of the uploaded data block is the same as the hash value of the data block stored in the second storage space.

11. The method of claim 7, wherein a uploaded data block in the first storage space is determined as a repetitive data block upon the condition that the uploaded data block also exists in the second storage space.

12. The method of claim 7, wherein a method of downloading the file from the server comprises:
the client obtains the hash value of each data block of the file from the hash list stored in the database;
the client downloads data blocks of the file from the second storage space according to the first pointers of the data blocks from the server when the hash values of the data blocks exist in the hash list stored in the database;
the client downloads the data blocks from a third storage space according to the second pointers of the data blocks when the hash values of the data blocks does not exist in the hash list stored in the database;
the client combines all downloaded data blocks to generate the file in the client according to the sequence number of each downloaded data block;
the client calculates the hash value of the generated file and determines if the calculated hash value of the generated file exists in the hash list stored in the database; and
the client displays the generated file when the calculated hash value of the generated file exists in the hash list stored in the database.

13. A non-transitory computer-readable medium having stored thereon instructions that, when executed by a server, the server in electronic communication with a plurality of clients, causing the server to perform a data block backup method, the method comprising:
dividing a file into two or more data blocks and saving a hash value of each data block into a hash list corresponding to the file;
uploading the hash list corresponding to the file into the database and each data block of the file into a first storage space of the server according to a sequence number of each data block of the file;
deleting repetitive data blocks from the first storage space when the uploaded data blocks of the file exist in a second storage space of the server;
removing the uploaded data blocks of the file into the second storage space from the first storage space when the uploaded data blocks of the file do not exist in the second storage space of the server;
backing up the repetitive data blocks by removing the repetitive data blocks from the first storage space into a third storage space of the server when the repetitive data blocks are not backed up, and backing up the uploaded data blocks of the file by removing the uploaded data blocks of the file from the second storage space into the third storage space; and
adding a first pointer corresponding to each uploaded data block of the file in the second storage space and a second pointer corresponding to each uploaded data block of the file in the third storage space into the database.

14. The non-transitory computer-readable medium of claim 13, wherein a method of dividing the file by the server comprises:
the server divides the file into two or more data blocks;
the server calculates the hash value of each data block; and
the server saves the hash value of each data block into the hash list.

15. The non-transitory computer-readable medium of claim 13, wherein the sequence number of each data block is generated in an alphabetical order or in a numerical order.

16. The non-transitory computer-readable medium of claim 13, wherein the uploaded data block exists in the second storage space upon the condition that the hash value of the uploaded data block is the same as the hash value of the data block stored in the second storage space.

17. The non-transitory computer-readable medium of claim 13, wherein a uploaded data block in the first storage space is determined as a repetitive data block upon the condition that the uploaded data block also exists in the second storage space.

18. The non-transitory computer-readable medium of claim 13, wherein a method of downloading the file from the server comprises:
the client obtains the hash value of each data block of the file from the hash list stored in the database;
the client downloads data blocks of the file from the second storage space according to the first pointers of the data blocks from the server when the hash values of the data blocks exist in the hash list stored in the database;
the client downloads the data blocks from a third storage space according to the second pointers of the data blocks when the hash values of the data blocks does not exist in the hash list stored in the database;
the client combines all downloaded data blocks to generate the file in the client according to the sequence number of each downloaded data block;
the client calculates the hash value of the generated file and determines if the calculated hash value of the generated file exists in the hash list stored in the database; and
the client displays the generated file when the calculated hash value of the generated file exists in the hash list stored in the database.
